(19) United States
(12) Patent Application Publication
(10) Pub. No.: US 2020/0240369 A1
(43) Pub. Date: Jul. 30, 2020

(54) COMBUSTION METHOD OF LIQUID FUEL

(71) Applicants: Yoshihiro Jahana, Asaka-shi (JP); Masanori Ito, Tokyo (JP)

(72) Inventors: Yoshihiro JAHANA, Asaka-shi (JP); Feifei ITO, Tokyo (JP); Masanori ITO, Tokyo (JP)

(21) Appl. No.: 16/261,340

(22) Filed: Jan. 29, 2019

(51) Int. Cl. F02M 25/12

(52) U.S. Cl. CPC F02M 25/12

(57) ABSTRACT

A combustion method of liquid fuel is disclosed. The combustion method includes adding a gas having a higher flame propagation rate than the liquid fuel to the air, promoting mixing of the fuel and the air by combustion of the gas, and decomposing molecules constituting the liquid fuel into molecules with a lower molecular weight to perform combustion.

### CROSS-REFERENCE TO RELATED APPLICATIONS

The entire disclosure of Japanese Patent Application No. 2016-153683, filed on Aug. 4, 2016 and issued on May 23, 2018 as Japanese Patent No. 6328186, is hereby incorporated herein by reference.

### TECHNICAL FIELD

The present invention relates to a method of efficiently combusting a polymer liquid fuel such as gasoline, diesel or heavy oil, a gas fuel, a solid fuel or a mixed fuel thereof.

### BACKGROUND ART

Internal combustion engines using hydrogen as a main fuel, and combustion methods that entail mixing hydrogen gas in intake air are known from the following background art.

Japanese Patent No. 5830035 discloses an internal combustion engine that uses hydrogen as a main fuel, in which the amounts of a nitrogen compound such as ammonia and hydrogen to be sent to a combustion chamber are set based on the operating state of the internal combustion engine, and the flow rate of oxygen or the nitrogen compound to be supplied to a decomposer that decomposes the nitrogen compound to generate hydrogen is adjusted based on the amount of the nitrogen compound and hydrogen sent to the combustion chamber.

Japanese Patent No. 4837694 discloses controlling the amount of hydrogen gas to be injected during intake as a control method of an internal combustion engine using a mixed fuel of diesel and another fuel as a main fuel. That is, when delaying the injection timing of the main fuel from the standard timing in order to reduce noise and vibration, it is disclosed that the hydrogen gas concentration is made higher than the flammable limit.

Japanese Patent No. 4251321 discloses reforming a fuel with a reformer and combusting a fuel component obtained by the reforming process in a combustion chamber to obtain stable combustion, with hydrogen gas mentioned in particular as a reformed gas.

Further, although hydrogen is not used, Japanese Patent Application Publication No. 2000-213444 discloses a method of controlling the ignition timing of a diesel engine that supplies air and fuel to a compression chamber of the engine, compresses a gaseous mixture of the air and fuel, and performs combustion by igniting the mixture at a desired timing. The description of prior art in Japanese Patent Application Publication No. 2000-213444 discloses a method of suppressing autoignition by supplying to an internal combustion engine a reformed gas produced by reducing the molecular weight of hydrocarbons serving as fuel by cracking. The description of prior art also discloses an improvement of the flame propagation rate in a combustion chamber by reforming a portion of fuel to produce gaseous aldehydes which are added and supplied in a small amount to a cylinder of a gasoline engine by a separate route from the fuel.

The internal combustion engine disclosed in Japanese Patent No. 5830035 uses hydrogen as a main fuel and does not improve combustion efficiency by adding hydrogen to the combustion gas. Also, since ordinary gasoline or heavy oil is not used as the main fuel, there is a cost disadvantage.

The method disclosed in Japanese Patent No. 4837694 slows down combustion while reducing ignition delay by making the concentration of hydrogen gas higher than the flammable limit, and also improves combustion in a medium- to high-load region. However, the combustion speed of the main fuel is not quickened by the addition of hydrogen gas.

Although causing a reformed gas to contain hydrogen gas as disclosed in Japanese Patent No. 4251321 is conventionally performed, regarding hydrogen gas simply as a fuel and physically decomposing a fuel composed of hydrocarbons into smaller molecules does not facilitate combustion of a main fuel.

Japanese Patent Application Publication No. 2000-213444 discloses increasing the flame propagation rate in the combustion chamber by reducing the molecular weight of the fuel by cracking and adding a small amount of gaseous aldehydes. However, no mention is made of the phenomenon of the polymer chain constituting a fuel being broken by the addition of a small amount of hydrogen gas.

The present inventors found that by mixing a small amount of hydrogen gas (flame propagation rate: 1000 m/sec or more) in the intake air, which is faster than the flame propagation rate of a polymeric hydrocarbon constituting a fuel (several tens of m/sec), the rapid combustion of the hydrogen gas promotes the mixing of air and the main fuel (polymeric hydrocarbon), and breaks the carbon-carbon bonds of the polymeric hydrocarbon to reduce the molecular weight, thereby facilitating combustion of the depolymerized hydrocarbon.

The present inventors confirmed that the rated performance is obtained at a steady load in an engine unit test or a running test on a chassis dynamo. However, when the load fluctuates, a state of incomplete combustion such as black smoke occurs, and so fuel consumption will be several tens of percent higher than the rated performance when the engine is operated on a vessel at sea or in an automobile on the road.

### BRIEF SUMMARY

The present invention has been made on the basis of the above findings, and has as an object to provide a combustion method that, when performing combustion by supplying air to a liquid fuel, a gas fuel, a solid fuel, or a mixed fuel thereof, performs combustion by adding a gas such as hydrogen gas having a higher flame propagation rate than the fuel to the air, promoting mixing of the fuel and the air by combustion of the gas, and decomposing molecules constituting the fuel into molecules with a lower molecular weight.

The additive amount of the gas having a higher flame propagation rate is very slight with respect to the amount of air necessary for complete combustion of the fuel, and is preferably 0.01% or more and 0.1% or less by volume.

Further, the additive amount of the gas having a high flame propagation rate may be changed in accordance with an output increase/decrease operation of a combustion apparatus.

For example, in the case where hydrogen gas is generated by electrolysis of water, the current value of the electrolysis is controlled, and in the case where hydrogen gas is stored in a cylinder, the opening degree of the flow control valve is controlled.

According to the combustion method of liquid fuel of the present invention, the entire amount of the injected fuel is combusted (complete combustion), and so generation of harmful substances such as particulate matter, nitrogen oxides, sulphur oxides and the like is suppressed.

The present inventors performed multiple driving experiments using trucks and cruising experiments using fishing boats. As a result, the effect of reducing fuel consumption by 10 to 30 percent was confirmed. In particular, the fuel reduction effect when the load fluctuation of the engine was large was remarkable.

### BRIEF DESCRIPTION OF THE DRAWINGS

FIG. 1 is a drawing for describing an example in which the combustion method of liquid fuel according to the present invention has been applied to a marine diesel engine.

FIG. 2 is a drawing for describing an example in which the combustion method of liquid fuel according to the present invention has been applied to a gas turbine.

### DETAILED DESCRIPTION

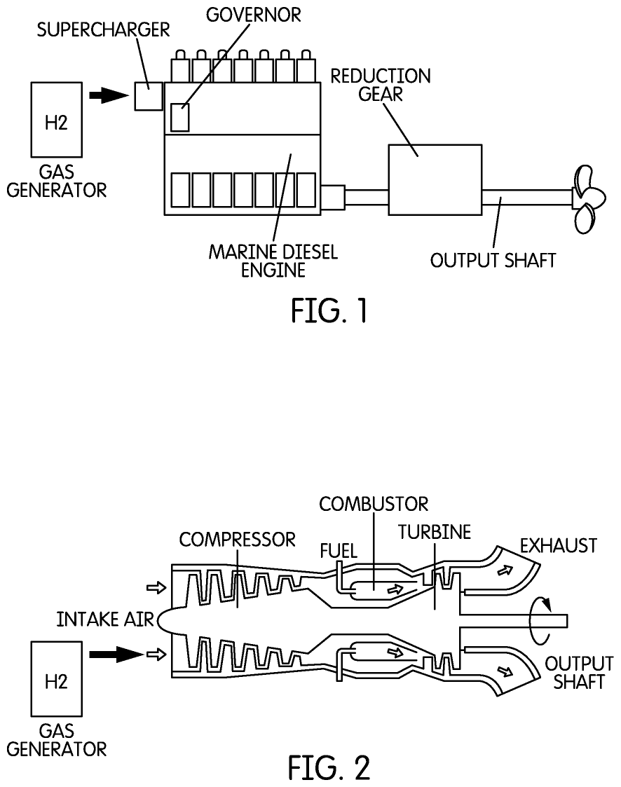

When applied to a marine diesel engine, as shown in FIG. 1, gas from a generator of gas with a high flame propagation rate, such as hydrogen, is supplied to a supercharger. For marine diesel engines without a supercharger, hydrogen gas is supplied from an air cleaner.

As the gas generator, a gas cylinder may be used in addition to a hydrogen gas generating device such as an electrolysis apparatus.

FIG. 2 shows an example in which the present invention is applied to a gas turbine. In this embodiment, the gas generator is disposed in front of an air intake. Hydrogen gas or the like generated by the gas generator is mixed with intake air, with the air and gas mixture compressed and then mixed with fuel to be combusted.

In the above combustion process, when the hydrogen gas is added to the intake at a volume ratio of for example 0.01% or more and 0.1% or less, the hydrogen gas is combusted firstly. Since the flame propagation rate of the hydrogen gas is as fast as 1000 m/sec, agitation of the fuel and the intake air is promoted, and the fuel is made into micronized particles and mixed into the air.

Furthermore, impact of flame propagation of the hydrogen gas breaks the carbon-carbon bonds of the polymeric hydrocarbon molecules constituting the fuel, whereby the polymeric hydrocarbon molecules decompose into molecules with lower molecular weight. In this way complete combustion can be achieved by the fuel being micronized and polymers constituting the fuel being made into smaller molecules.

### Experiment Example 1

In order to confirm the energy saving effect of the hydrogen gas mixed fuel, testing equipment was installed on a test ship (Genkichi Maru) that performed an actual cruise. Details of the experiment are given below.
Experiment date: February 2 (Monday) and 3 (Tuesday), 2015
Waters off Cape Goza, Wagu Town, Shima City, Mie Prefecture, Japan
Description of actual cruise: In an offshore area of Hama island, a sign was set 2 nautical miles away on the 260 degree azimuth line, and the ship traveled one round trip for each of the following six cases consisting of two conditions of engine rotation speed and three conditions of gas supply amount (mixing amount of hydrogen gas).
(1) Engine rotation speed: 450 rpm
   Gas supply amount: None, 4,000 cc/min, 5,000 cc/min
(2) Engine rotation speed: 550 rpm
   Gas supply amount: None, 6,000 cc/min, 7,000 cc/min

The experiment results are summarized in the following Table 1.

TABLE 1

| Gas supply amount | None | 4,000 cc/min | 5,000 cc/min |
|---|---|---|---|
| Average rpm | 447 rpm | 444 rpm | 445 rpm |
| Fuel savings | 0% | 5% | 4% |
| Gas supply amount | None | 6,000 cc/min | 7,000 cc/min |
| Average rpm | 546 rpm | 545 rpm | 545 rpm |
| Fuel savings | 0% | 4% | 9% |

### Experiment Example 2

Name of test ship: No. 8 Daikei Maru
Experiment date: Feb. 28 to Mar. 2, 2015
Open sea off Omi Island, Nagato City, Yamaguchi Prefecture, Japan

The experiment results are summarized in the following Table 2 and Table 3.

TABLE 2

| | Gas supply | | | Supply | Return | Consumption | Measurement | |
|---|---|---|---|---|---|---|---|---|
| Operating condition | amount (cc/min) | RPM | Speed (knots) | amount (l) | amount (l) | amount (l) | time (min) | Savings (%) |
| With gas | 3000 | 1200 | 13.4 | 30.93 | 10.42 | 20.51 | 14 | 5.5 |
| With gas | 3000 | 1200 | 13.8 | 28.61 | 10.27 | 18.34 | 13 | 7.0 |
| Without gas | 0 | 1200 | 13.8 | 15.70 | 5.32 | 10.38 | 7 | — |
| Without gas | 0 | 1200 | 13.7 | 17.95 | 6.34 | 11.61 | 8 | — |

TABLE 3

| | Gas supply | | | Supply | Return | Consumption | Measurement | |
|---|---|---|---|---|---|---|---|---|
| Operating condition | amount (cc/min) | RPM | Speed (knots) | amount (l) | amount (l) | amount (l) | time (min) | Savings (%) |
| Wac-Box | 2500 | 1200 | 14.03 | 17.74 | 6.45 | 11.29 | 8 | 29.17 |
| Wac-Box | 2500 | 1200 | ? | 17.86 | 6.57 | 11.29 | 8 | 29.17 |
| Wac-Box | 3200 | 1200 | 14.20 | 19.96 | 7.36 | 12.60 | 10 | 25.60 |
| Wac-Box | 3200 | 1200 | 14.18 | 19.05 | 7.19 | 11.86 | 10 | 27.62 |
| Without gas | 0 | 1200 | 13.80 | 15.71 | 5.32 | 10.38 | 7 | — |
| Without gas | 0 | 1200 | 13.70 | 17.95 | 6.34 | 11.61 | 8 | — |

### Experiment Example 3

Experimental example 3 was conducted using an automobile (truck) in order to confirm the energy saving effect of fuel mixed with hydrogen gas.
Vehicle: Nissan diesel truck (garbage truck converted to a tow truck)
Engine displacement: 4,570 cc

Vehicle weight: 4,285 kg
Mileage: 86,895 km
Fuel: diesel
Bosch injectors

Experiment results in the case of not adding hydrogen gas are shown in Table 4, while experiment results in the case of adding hydrogen gas are shown in Table 5.

TABLE 4

| | 1-hour | 2-hour | Amps/gas | Distance traveled | Distance traveled | Total | Fuel supply | Average |
|---|---|---|---|---|---|---|---|---|
| Experiment day | mileage | mileage | amount | on ordinary roads | on expressways | distance | amount | consumption |
| April 22 | 23 | 54.5 | None | 124.0 | 0 | 124.0 | 15.72 | 7.88 |
| April 24 | 22.3 | 54.1 | None | 139.4 | 0 | 139.0 | 19.26 | 7.23 |
| Two-day total | | | | | | 263.4 | 34.98 | 7.53 |

TABLE 5

| | 1-hour | 2-hour | Amps/gas | Distance traveled | Distance traveled | Total | Fuel supply | Average | |
|---|---|---|---|---|---|---|---|---|---|
| Experiment day | mileage | mileage | amount | on ordinary roads | on expressways | distance | amount | consumption | Savings (%) |
| April 23 | 15.0 | 39.5 | 5 A/443 cc | 155.8 | 0 | 155.8 | 19.89 | 7.83 | 3.98 |
| April 25 | 29.6 | 63.9 | 9 A/835 cc | 131.1 | 0 | 131.1 | 13.99 | 9.37 | 24.43 |
| April 27 | 23.7 | 53.4 | 9 A/835 cc | 146.0 | 0 | 146.0 | 16.97 | 8.60 | 14.20 |
| April 28 | 5.5 | Destination | 13 A/1223 cc | 32.0 | 111.0 | 143.3 | 17.64 | 8.12 | 7.83 |
| | | reached | | | | | | | |
| | | under 2 hr | | | | | | | |

In the above experiment on April 23, due to natural congestion the one-hour mileage was as low as 15 km, with the adverse effects of stop-and-go traffic being apparent. Even when the idling speed was reduced by 200 rpm with the addition of 5 A (443 cc) of gas, starting was possible without knocking or judder despite a rougher clutch operation than a typical start in second gear.

In the running on April 28 in which expressway travel accounted for a large share, there was a greater focus on covering distance than fuel economy. As a result, acceleration and top speed were objectives, and even with intermittent traffic jams on the metropolitan expressway, a 7.83% improvement in fuel efficiency was achieved. It seems that there was an improvement in torque marked by responsiveness on uphill slopes and the ability to overtake other vehicles without slowing down.

With a 9 A (835 cc) gas addition, driving was possible with no knocking even with idling in fourth gear. With a 13 A (1223 cc) gas addition, the engine sound was definitely lighter, and the response also improved greatly.

In the illustrated examples, the combustion method of liquid fuel according to the present invention was applied to a marine diesel engine and a truck. In addition, application is also possible to a generator, a boiler, and an engine for a passenger car or a special-purpose vehicle, as well as to an energy-generating device using gas fuel or a solid fuel such as pulverized coal.

1. A combustion method of liquid fuel for an energy generating apparatus that performs combustion by supplying air to the liquid fuel, the method comprising:
adding a gas having a higher flame propagation rate than the liquid fuel to the air, the gas having a higher flame propagation rate being a hydrogen gas;
promoting mixing of the liquid fuel and the air by combustion of the gas; and
decomposing molecules constituting the liquid fuel into molecules with a lower molecular weight to perform combustion, wherein
an additive amount of the gas having a higher flame propagation rate is 0.01% or more and 0.1% or less by volume with respect to the amount of air necessary for complete combustion of the fuel.

2. (canceled)

3. (canceled)

4. The combustion method of liquid fuel according to claim 1, wherein
the additive amount of the gas having a higher flame propagation rate is changed in accordance with an output increase/decrease operation of a combustion apparatus.

5. The combustion method of liquid fuel according to claim 1, wherein
the liquid fuel is a mixed fuel to which a gas fuel or a solid fuel is mixed.
